(19) United States
(12) Patent Application Publication
(10) Pub. No.: US 2023/0175407 A1
(43) Pub. Date: Jun. 8, 2023

(54) DOVETAILED COMPOSITE OUTLET GUIDE VANE ASSEMBLY AND METHOD OF ASSEMBLING THEREOF

(71) Applicant: General Electric Company, Schenectady, NY (US)

(72) Inventors: Li Zheng, Latham, NY (US); Nicholas Joseph Kray, Mason, OH (US); Changjie Sun, Clifton Park, NY (US)

(21) Appl. No.: 17/541,859

(22) Filed: Dec. 3, 2021

(51) Int. Cl. F01D 5/30; F01D 9/02; F01D 25/28

(52) U.S. Cl. CPC F01D 5/3007; F01D 9/02; F01D 25/28; F05D 2230/60; F05D 2220/32; F05D 2300/603

(57) ABSTRACT

A system for an outlet guide vane assembly and method of assembly thereof are provided herein. The outlet guide vane assembly generally includes a composite outlet guide vane that includes a monolithic body extending in an axial direction from a base to a top, as well as an anchor bracket. At least one of the base and the top includes a bulbous profile having a thickness in a radial direction that is greater than a thickness of the monolithic body in the radial direction, where the radial direction is orthogonal to the axial direction. The anchor bracket generally includes an anchor base, an engagement slot, and at least one side structure defining the engagement slot.

### FIELD OF THE DISCLOSURE

The present subject matter relates generally to outlet guide vanes and, more specifically, to a dovetailed composite outlet guide vane assembly and method of assembling thereof.

### BACKGROUND OF THE PRESENT DISCLOSURE

Rotating blades in turbomachines such as gas turbines can be subjected to extremely high temperatures and high speeds during operation. In a gas turbine, an axial flow compressor supplies air under pressure for expansion through a turbine section and generally comprises a rotor surrounded by a casing. The casing generally comprises two half cylindrical sections, removably joined together. The rotor includes a plurality of stages, each comprising a rotor disc with a single row of blades located about its outer rim. The stages are joined together and to a turbine driven shaft. The casing supports a plurality of stages or annular rows of stator vanes. The stator vane stages are located between the compressor blade stages, helping to compress the air forced through the compressor and directing the air flow into the next stage of rotor blades at the proper angle to provide a smooth, even flow through the compressor.

Some turbine assemblies, including those made of metal, attach the stator vane to the casing. However, these assemblies may include many types of supports that are also made out of metal, potentially making the assemblies bulky. These assemblies may also be subject to wear due to the metal-to-metal contact, thereby increasing friction in the vane system, which in turn can prevent or interfere with movement of the vanes which could result in engine stall. Maintenance to repair the turbomachines involves removing the compressor casing and tearing down the stator vane assembly. This can be expensive, time-consuming and require skilled workers. Further, bulky assemblies may be heavier, leading to less efficient operations of the turbomachines.

Accordingly, alternative outlet guide vanes would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic representation of an exemplary gas turbine which may be inspected according to embodiments of the present disclosure;

FIG. 2 is a partial, cross-sectional view of a high-pressure turbine within the gas engine turbine;

FIG. 3 shows a cross-sectional illustration of a high-pressure compressor with a plurality of compressor stages;

FIG. 4 is a side view of an outlet guide vane assembly for the gas turbine engine;

FIG. 5 is an illustration of an anchor bracket for attaching the outlet guide vane assembly to the gas turbine engine;

FIG. 6 is a cross-section of the outlet guide vane assembly attached to the gas turbine engine;

FIG. 7 shows a side view of an embodiment of the outlet guide vane assembly for the gas turbine engine; and

FIG. 8 illustrates a flow diagram of one embodiment of a method for attaching the outlet guide vane assembly in accordance with aspects of the present subject matter.

### DETAILED DESCRIPTION

Reference now will be made in detail to embodiments of the present disclosure, one or more examples of which are illustrated in the drawings. Each example is provided by way of explanation of the present disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the terms “first,” “second,” and “third” may be used interchangeably to distinguish one component from another and are not intended to signify location or importance of the individual components.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a,” “an,” and “the” include plural referents unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about,” is not to be limited to the precise value specified. In some instances, the approximating language may correspond to the precision of an instrument for measuring the value. For example, the approximating language may refer to being within a 1, 2, 4, 10, 15, or 20 percent margin. These approximating margins may apply to a single value, either or both endpoints defining numerical ranges, and/or the margin for ranges between endpoints.

Additionally, the term “rotor blade,” without further specificity, is a reference to the rotating blades of either the compressor or the turbine, which include both compressor rotor blades and turbine rotor blades. The term “stator vane,” without further specificity, is a reference to the stationary vane of either the compressor or the turbine, which include both compressor stator vanes and turbine vane blades. The term “compressor blade,” without further specificity, is a reference to both compressor rotor blades and compressor stator blades. The term “blades” will be used herein to refer to either type of blade. Thus, without further specificity, the term “blades” is inclusive to all type of turbine engine blades, including compressor rotor blades, compressor stator blades, turbine rotor blades, and turbine stator blades. Further, the descriptive or standalone term “blade surface” may reference any type of turbine or compressor blade, and may include any or all portions of the blade, including the suction side face, pressure side face, blade tip, blade shroud, platform, root, and shank.

Finally, given the configuration of compressor and turbine about a central common axis, as well as the cylindrical configuration common to many combustor types, terms describing position relative to an axis may be used herein. In this regard, it will be appreciated that the term “radial” refers to movement or position perpendicular to an axis. Related to this, it may be required to describe relative distance from the central axis. In this case, for example, if a first component resides closer to the central axis than a second component, the first component will be described as being either “radially inward” or “inboard” of the second component. If, on the other hand, the first component resides further from the central axis than the second component, the first component will be described herein as being either “radially outward” or “outboard” of the second component. Additionally, as will be appreciated, the term “axial” refers to movement or position parallel to an axis. Finally, the term “circumferential” refers to movement or position around an axis. As mentioned, while these terms may be applied in relation to the common central axis that extends through the compressor and turbine sections of the engine, these terms also may be used in relation to other components or sub-systems of the engine.

In general, the present subject matter relates to outlet guide vanes and, more specifically, to a composite outlet guide vane assembly including an outlet guide vane with a bulbous end or bulbous profile (e.g., dovetailed end) and method of assembly thereof.

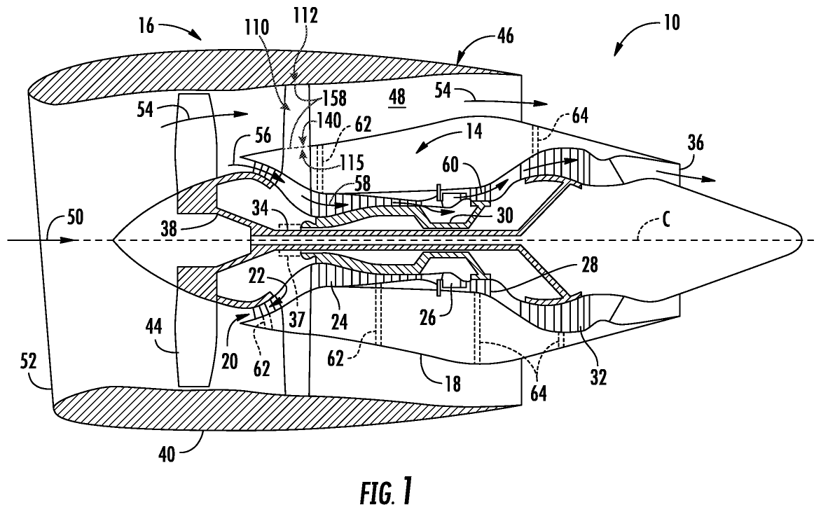

Referring now to the drawings, FIG. 1 illustrates a cross-sectional view of one embodiment of a gas turbine engine 10 that may be utilized within an aircraft in accordance with aspects of the present subject matter, with the gas turbine engine 10 being shown having a longitudinal or axial centerline axis C extending therethrough for reference purposes. In general, the gas turbine engine 10 may include a core gas turbine engine (indicated generally by reference character 14) and a fan section 16 positioned upstream thereof. The core engine 14 may generally include a substantially tubular outer casing 18 that defines an annular inlet 20. In addition, the outer casing 18 may further enclose and support a booster compressor 22 for increasing the pressure of the air that enters the core engine 14 to a first pressure level. A high-pressure, multi-stage, axial-flow compressor 24 may then receive the pressurized air from the booster compressor 22 and further increase the pressure of such air. The pressurized air exiting the high-pressure compressor 24 may then flow to a combustor 26 within which fuel is injected into the flow of pressurized air, with the resulting mixture being combusted within the combustor 26. The high energy combustion products are directed from the combustor 26 along the hot gas path of the gas turbine engine 10 to a first (high-pressure) turbine 28 for driving the high-pressure compressor 24 via a first (high-pressure) drive shaft 30, and then to a second (low-pressure) turbine 32 for driving the booster compressor 22 and fan section 16 via a second (low-pressure) drive shaft 34 that is generally coaxial with first drive shaft 30. After driving each of turbines 28 and 32, the combustion products may be expelled from the core engine 14 via an exhaust nozzle 36 to provide propulsive jet thrust.

It should be appreciated that each compressor 22, 24 may include a plurality of compressor stages, with each stage including both an annular array of stationary compressor vanes and an annular array of rotating compressor blades positioned immediately downstream of the compressor vanes. Similarly, each turbine 28, 32 may include a plurality of turbine stages, with each stage including both an annular array of stationary nozzle vanes and an annular array of rotating turbine blades positioned immediately downstream of the nozzle vanes.

Additionally, as shown in FIG. 1, the fan section 16 of the gas turbine engine 10 may generally include a rotatable, axial-flow fan rotor assembly 38 that is configured to be surrounded by an annular fan casing 40. It should be appreciated by those of ordinary skill in the art that the fan casing 40 may be configured to be supported relative to the core engine 14 by a plurality of substantially radially-extending, circumferentially-spaced outlet guide vanes 110. As such, the fan casing 40 may enclose the fan rotor assembly 38 and its corresponding fan rotor blades 44. Moreover, a downstream section 46 of the fan casing 40 may extend over an outer portion of the core engine 14 so as to define a secondary, or by-pass, airflow conduit 48 that provides additional propulsive jet thrust.

It should be appreciated that, in several embodiments, the second (low-pressure) drive shaft 34 may be directly coupled to the fan rotor assembly 38 to provide a direct-drive configuration. Alternatively, the second drive shaft 34 may be coupled to the fan rotor assembly 38 via a speed reduction device 37 (e.g., a reduction gear or gearbox) to provide an indirect-drive or geared drive configuration. Such a speed reduction device(s) may also be provided between any other suitable shafts and/or spools within the gas turbine engine 10 as desired or required.

During operation of the gas turbine engine 10, it should be appreciated that an initial air flow (indicated by arrow 50) may enter the gas turbine engine 10 through an associated inlet 52 of the fan casing 40. The air flow 50 then passes through the fan blades 44 and splits into a first compressed air flow (indicated by arrow 54) that moves through airflow conduit 48 and a second compressed air flow (indicated by arrow 56) which enters the booster compressor 22. The pressure of the second compressed air flow 56 is then increased and enters the high-pressure compressor 24 (as indicated by arrow 58). After mixing with fuel and being combusted within the combustor 26, combustion products 60 exit the combustor 26 and flow through the first turbine 28. Thereafter, the combustion products 60 flow through the second turbine 32 and exit the exhaust nozzle 36 to provide thrust for the gas turbine engine 10.

As indicated above, the gas turbine engine 10 may also include a plurality of access ports defined through its casings and/or frames for providing access to the interior of the core engine 14. For instance, as shown in FIG. 1, the gas turbine engine 10 may include a plurality of compressor access ports 62 (only three of which are shown) defined through the outer casing 18 for providing internal access to one or both of the compressors 22, 24. Similarly, as shown in the illustrated embodiment, the gas turbine engine 10 may include a plurality of turbine access ports 64 (only three of which are shown) defined through the outer casing 18 for providing internal access to one or both of the turbines 28, 32. In several embodiments, the access ports 62, 64 may be spaced apart axially along the core engine 14. For instance, the compressor access ports 62 may be spaced apart axially along each compressor 22, 24 such that at least one access port compressor is located at each compressor stage for providing access to the compressor vanes and blades located within such stage. Similarly, the turbine access ports 64 may be spaced apart axially along each turbine 28, 32 such that at least one turbine access port 64 is located at each turbine stage for providing access to the nozzle vanes and turbine blades located within such stage.

It should be appreciated that, although the access ports 62, 64 are generally described herein with reference to providing internal access to one or both of the compressors 22, 24 and/or for providing internal access to one or both of the turbines 28, 32, the gas turbine engine 10 may include access ports providing access to any suitable internal location of the gas turbine engine 10, such as by including access ports that provide access within the combustor 26 and/or any other suitable component of the gas turbine engine 10. Furthermore, the present disclosure may be used to inspect any component of the gas turbine engine 10.

It will be appreciated that the exemplary gas turbine engine 10 depicted in FIG. 1 and described above is provided by way of example only. In other embodiments, the gas turbine engine 10 may have any other suitable configuration, such as a geared connection with the fan 44; a variable pitch fan; any suitable number of shafts/spools, compressors, or turbines; etc. Additionally, although depicted as a ducted turbofan engine, in other embodiments, the gas turbine engine 10 may be configured as an unducted turbofan engine, a turboshaft engine, a turboprop engine, a turbojet engine, etc.

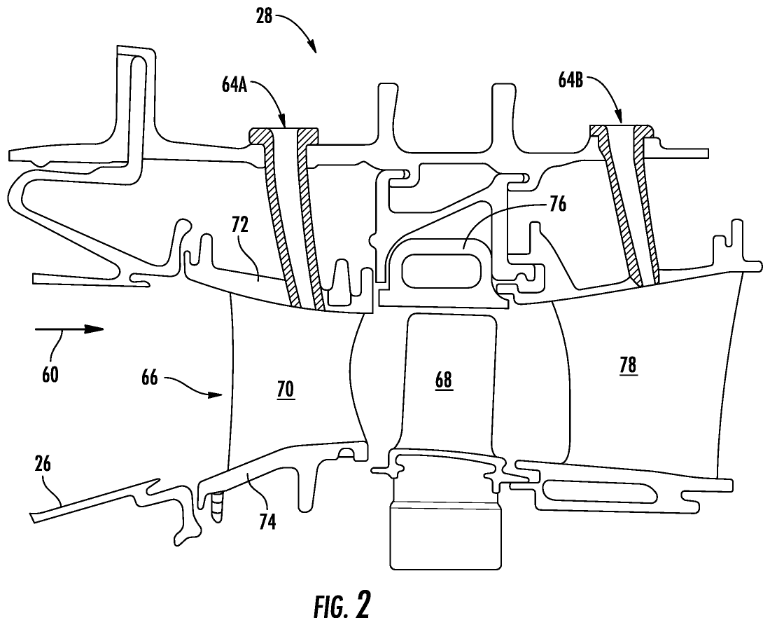

Referring now to FIG. 2, a partial, cross-sectional view of the first (or high-pressure) turbine 28 described above with reference to FIG. 1 is illustrated in accordance with embodiments of the present subject matter. As shown, the first turbine 28 may include a first stage turbine nozzle 66 and an annular array of rotating turbine blades 68 (one of which is shown) located immediately downstream of the nozzle 66. The nozzle 66 may generally be defined by an annular flow channel that includes a plurality of radially-extending, circularly-spaced nozzle vanes 70 (one of which is shown). The vanes 70 may be supported between a number of arcuate outer bands 72 and a number of arcuate inner bands 74. Additionally, the circumferentially spaced turbine blades 68 may generally be configured to extend radially outwardly from a rotor disk (not shown) that rotates about the centerline axis C (FIG. 1) of the gas turbine engine 10. Moreover, a turbine shroud 76 may be positioned immediately adjacent to the radially outer tips of the turbine blades 68 so as to define the outer radial flowpath boundary for the combustion products 60 flowing through the turbine 28 along the hot gas path of the gas turbine engine 10.

As indicated above, the turbine 28 may generally include any number of turbine stages, with each stage including an annular array of nozzle vanes and follow-up turbine blades 68. For example, as shown in FIG. 2, an annular array of nozzle vanes 78 of a second stage of the turbine 28 may be located immediately downstream of the turbine blades 68 of the first stage of the turbine 28.

Moreover, as shown in FIG. 2, a plurality of turbine access ports 64A, 64B may be defined through the turbine casing and/or frame, with each of the plurality of turbine access port 64A, 64B being configured to provide access to the interior of the turbine 28 at a different axial location. Specifically, as indicated above, the plurality of turbine access ports 64A, 64B may, in several embodiments, be spaced apart axially such that each of the plurality of turbine access port 64A, 64B is aligned with or otherwise provides interior access to a different stage of the turbine 28. For instance, as shown in FIG. 2, a first turbine access port 64A may be defined through the turbine casing/frame to provide access to the first stage of the turbine 28 while a second turbine access port 64B may be defined through the turbine casing/frame to provide access to the second stage of the turbine 28.

It should be appreciated that similar turbine access ports 64A, 64B may also be provided for any other stages of the turbine 28 and/or for any turbine stages of the second (or low-pressure) turbine 32. It should also be appreciated that, in addition to the axially spaced turbine access ports 64 shown in FIG. 2, access ports may be also provided at differing circumferentially spaced locations. For instance, in one embodiment, a plurality of circumferentially spaced access ports may be defined through the turbine casing/frame at each turbine stage to provide interior access to the turbine 28 at multiple circumferential locations around the turbine stage.

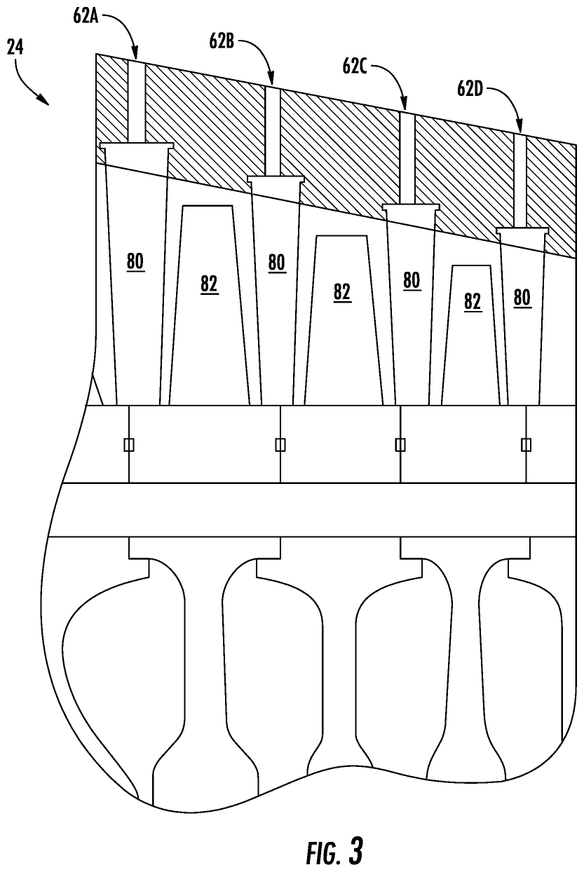

Referring now to FIG. 3, a partial, cross-sectional view of the high-pressure compressor 24 described above with reference to FIG. 1 is illustrated in accordance with embodiments of the present subject matter. As shown, the high-pressure compressor 24 may include a plurality of compressor stages, with each stage including both an annular array of fixed compressor vanes 80 (only one of which is shown for each stage) and an annular array of rotatable compressor blades 82 (only one of which is shown for each stage). Each row of compressor vanes 80 is generally configured to direct air flowing through the high-pressure compressor 24 to the row of compressor blades 82 immediately downstream thereof.

Moreover, as indicated above, the high-pressure compressor 24 may include a plurality of compressor access ports 62A, 62B, 62C, 62D defined through the compressor casing/frame, with each of the plurality of compressor access port 62A, 62B, 62C, 62D being configured to provide access to the interior of the compressor 24 at a different axial location. Specifically, in several embodiments, the plurality of compressor access ports 62A, 62B, 62C, 62D may be spaced apart axially such that each of the plurality of compressor access port 62A, 62B, 62C, 62D is aligned with or otherwise provides interior access to a different stage of the compressor 24. For instance, as shown in FIG. 3, first, second, third and fourth compressor access ports 62A, 62B, 62C, 62D are illustrated that provide access to four successive stages, respectively, of the high-pressure compressor 24.

It should be appreciated that similar access ports may also be provided for any of the other stages of the high-pressure compressor 24 and/or for any of the stages of the booster compressor 22. It should also be appreciated that, in addition to the axially spaced compressor access ports 62 shown in FIG. 3, access ports may be also provided at differing circumferentially spaced locations. For instance, in one embodiment, a plurality of circumferentially spaced access ports may be defined through the compressor casing/frame at each compressor stage to provide interior access to the high-pressure compressor 24 at multiple circumferential locations around the compressor stage.

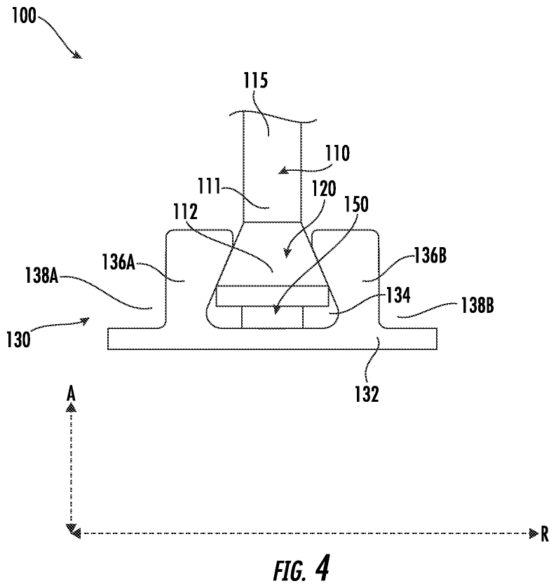

Referring now to FIG. 4, a perspective, schematic view of an outlet guide vane assembly 100 is shown in accordance with an exemplary embodiment of the present subject matter. The outlet guide vane assembly 100 includes an outlet guide vane 110 that includes a monolithic body 111 extending in an axial direction A from a base 112 to a top 115. The base 112 may be in a lower position along the axis A than the top 115. Further, at least one of the base 112 and the top 115 may include a bulbous profile 120. In an exemplary embodiment and as shown in FIG. 4, the bulbous profile 120 may be on the base 112. However, in at least some embodiments, the base 112 and the top 115 may both have the bulbous profile 120. The bulbous profile 120 has a thickness in a radial direction R (e.g., where the radial direction R is orthogonal to the axial direction A) that is greater than a thickness of the monolithic body 111 in the radial direction R, e.g., in a dovetailed shape. In an exemplary embodiment, the ratio of the thickness of the bulbous profile 120 to the thickness of the monolithic body 111 in the radial direction R is greater than about 1.2. In certain non-limiting embodiments where both the base 112 and the top 115 each have a bulbous profile 120, the thickness of the bulbous profile 120 of the base 112 and the thickness of the bulbous profile 120 of the top 115 may be substantially similar.

The outlet guide vane 110 is also made of a composite material. Using a composite material for outlet guide vanes 110 in a gas turbine engine 10 may provide additional advantages, such as lighter weights which result in greater efficiency in the turbomachine. In at least some exemplary embodiments, the composite material is a polymer matrix composite material, such as carbon composite, e.g., laminate and/or woven fibers.

The outlet guide vane 110 may, in some embodiments, be formed using additive manufacturing. Additive manufacturing technology may generally be described as fabrication of objects by building objects point-by-point, layer-by-layer, typically in a vertical direction. Such exemplary additive manufacturing methods may, for example, utilize an additive manufacturing technology that includes a powder bed fusion (PBF) technology, such as a direct metal laser melting (DMLM) technology, a selective laser melting (SLM) technology, a directed metal laser sintering (DMLS) technology, or a selective laser sintering (SLS) technology. In an exemplary PBF technology, thin layers of powder material are sequentially applied to a build plane and then selectively melted or fused to one another in a layer-by-layer manner to form one or more three-dimensional objects. Additively manufactured objects using one or more of these methods may be generally monolithic in nature and may have a variety of integral sub-components.

Additionally or alternatively, suitable additive manufacturing technologies include, for example, Fused Deposition Modeling (FDM) technology, Direct Energy Deposition (DED) technology, Laser Engineered Net Shaping (LENS) technology, Laser Net Shape Manufacturing (LNSM) technology, Direct Metal Deposition (DMD) technology, Digital Light Processing (DLP) technology, Vat Polymerization (VP) technology, Stereolithography (SLA) technology, and other additive manufacturing technology that utilizes an energy beam.

Other methods of fabrication are contemplated and within the scope of the present disclosure. For example, although the discussion herein refers to the addition of material to form successive layers, the presently disclosed subject matter may be practiced with any additive manufacturing technology or other manufacturing technology, including layer-additive processes, layer-subtractive processes, or hybrid processes.

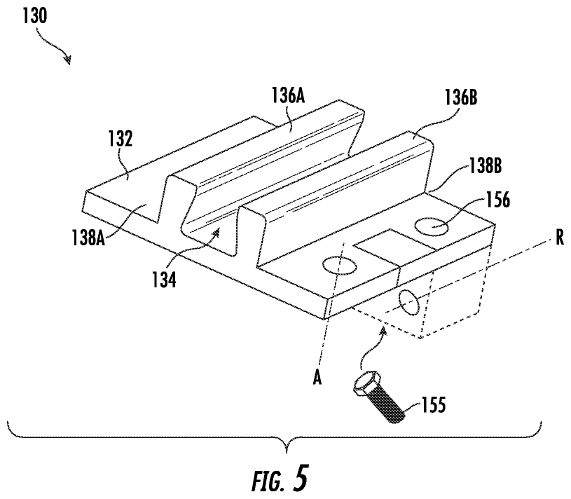

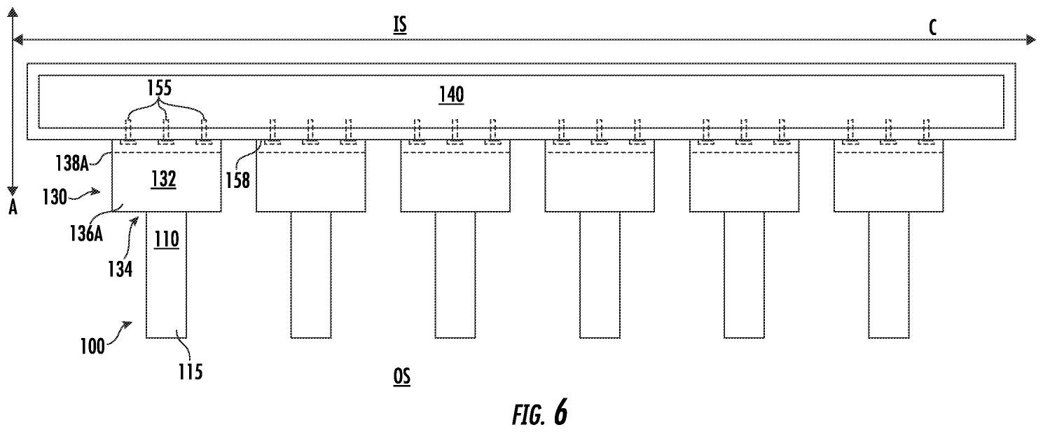

Additionally, in some exemplary embodiments, e.g., as shown in FIGS. 4 and 6, the outlet guide vane 110 is a stator vane. However, it will also be appreciated that the outlet guide vane 110 may refer to any static vane as shown in FIG. 6. The outlet guide vane 110, e.g., stator vane, may be attached to the gas turbine engine 10 at one or more attachment points 158 using an anchor bracket 130. Generally, the anchor bracket 130 may include an anchor base 132 and an engagement slot 134, where the engagement slot 134 is defined by at least one side structure 136. In some embodiments, the at least one side structure 136A, 136B may include at least two side structures 136A and 136B, as shown in FIGS. 4 and 5. Further, the anchor bracket 130 may also include a number of grooves 138A, 138B defined by the side structures 136, 136B and the anchor base 132. The grooves 138A and 138B may each have a large enough area to allow for the inclusion of one or more attachment members 155 to attach the anchor bracket 130 at the one or more attachment points 158. In some embodiments, the one or more attachment points 158 may refer to one or more points on an engine casing 140 and/or on the fan casing 40, as shown in FIG. 1.

In certain non-limiting embodiments, the bulbous end 120, e.g., the end of the monolithic body 111 with the bulbous profile 120, of the outlet guide vane 110 is configured to slide into the engagement slot 134 of the anchor bracket 130. The engagement slot 134 is large enough to allow the bulbous end 120 to fit within the engagement slot 134 but small enough that the bulbous end 120 will not fall out of the engagement slot 134. The engagement slot 134 may further be at least one of straight, tapered, and curved along the axial direction A. However, it will be appreciated that the engagement slot 134 may be any other shape that can be configured to receive the bulbous profile 120 of the outlet guide vane 110.

Further, a spacer 150 is placed between the outlet guide vane 110 and the anchor bracket 130, as shown in FIGS. 4 and 6. The spacer 150 interacts with the outlet guide vane 110 and/or the anchor bracket 130, e.g., through friction forces, to stay in place. However, it will be appreciated that the spacer 150 may alternatively or additionally be coupled to the outlet guide vane 110, the anchor bracket 130, or both, through mechanical and/or other means. In some embodiments, the spacer 150 may be a composite material, such as a polymer matrix composite material. For example, the polymer matrix composite materials may include one or more of carbon composite laminate and/or carbon composite woven fibers. Further, in some embodiments, the spacer 150 may be the same material as the outlet guide vane 110. Alternatively, however, the spacer 150 may be a metal, such as aluminum, titanium, nickel, and/or alloys thereof.

Referring now specifically to FIG. 6, the outlet guide vane assembly 100 may be attached via the anchor bracket 130 to the engine frame 140 of the gas turbine engine. The gas turbine engine, specifically, the high-pressure compressor 24 (not shown), defines an inner span IS that is closer to a central axis C of the gas turbine engine 10 and an outer span OS that is farther from the central axis C of the gas turbine engine 10 (e.g., closer to the outside of the gas turbine engine 10). As shown in FIG. 6, each outlet guide vane 110 may be part of the outlet guide vane assembly 100 such that the engine casing 140 has one or more outlet guide vane assemblies 100, such as two or more outlet guide vane assemblies 100, such as three or more outlet guide vane assemblies 100, etc. In some embodiments, all of the outlet guide vanes 110 in the turbomachine are part of the outlet guide vane assembly 100. However, it will be appreciated that in some embodiments, some of the outlet guide vanes 100 may be attached to the engine frame/casing 140 through other means.

The anchor bracket 130 may be attached to the inner span IS, the outer span OS, or both, using one or more attachment members 155. Additionally, referring briefly to FIG. 5, the anchor base 132 may include a plurality of openings 156 through which the one or more attachment members 155 extend. As mentioned previously, the grooves 138A and 138B, each have a large enough area to allow for the inclusion of the one or more attachment members 155 and/or the plurality of openings 156. The one or more attachment members 155 may extend through the plurality of openings 156 formed either axially (A) or radially (R) through the anchor bracket 130. The one or more attachment members 155 may be made of a metal material, such as nickel and/or nickel alloy (e.g., Inconel). In certain embodiments, the one or more attachment members 155 may be bolts, rods, screws, rivets, and/or any other type of fasteners. Further, the one or more attachment members 155 may refer to any number of attachment members 155 needed to safely secure the anchor bracket 130 to the engine frame 140. For example, the outlet guide vane assembly 100 may include two or more attachment members 155, such as three or more attachment members 155, such as four or more attachment members 155. In certain embodiments, the attachment members 155 will only use five or less attachment members 155, such as four or less attachment members 155, or such as three or less attachment members 155.

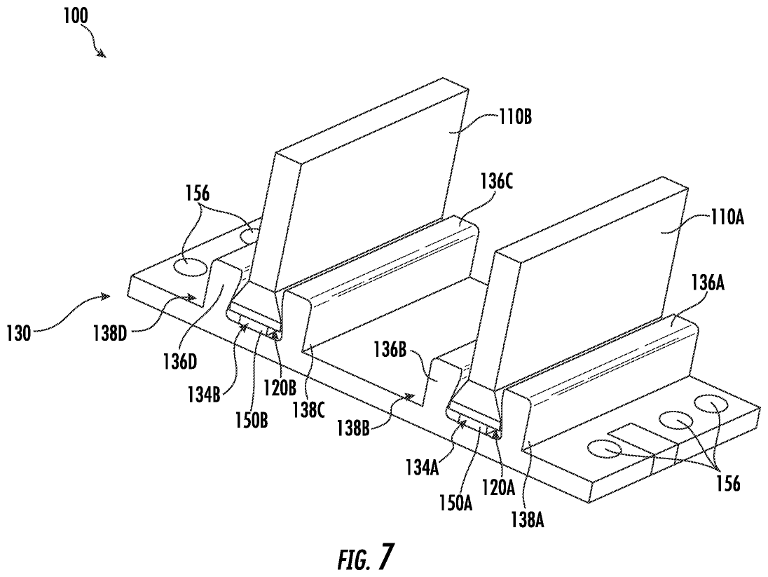

It will also be appreciated that the outlet guide vane assembly 100 may further include more than one anchor bracket 130, as shown in FIG. 7. For example, as mentioned above, the outlet guide vane 110 may include the bulbous profile 120 at the base 112 and/or the top 115, such as a first bulbous profile 120A at the base 112 and a second bulbous profile 120B at the top 115. The anchor bracket 130 in the outlet guide vane assembly 100 may be a first anchor bracket 130A and may further include a second anchor bracket 130B. The first anchor bracket 130A may be coupled with the first bulbous end 120A and the second anchor bracket 130B may be coupled with the second bulbous end 120B. For example, each bulbous profile 120A, 120B of the outlet guide vane 110 may be configured to slide into the engagement slot 134 of one of the first anchor bracket 130A or the second anchor bracket 130B. The outlet guide vane assembly 100 may be attached at an opposite end of the outlet guide vane 110 using the second anchor bracket 130B. Referring briefly to FIG. 1, the outlet guide vane 110 is shown schematically attached at the top 115 to the outer span OS with an anchor bracket 130, and at the base 112 at the inner span IS, e.g., the engine casing 140.

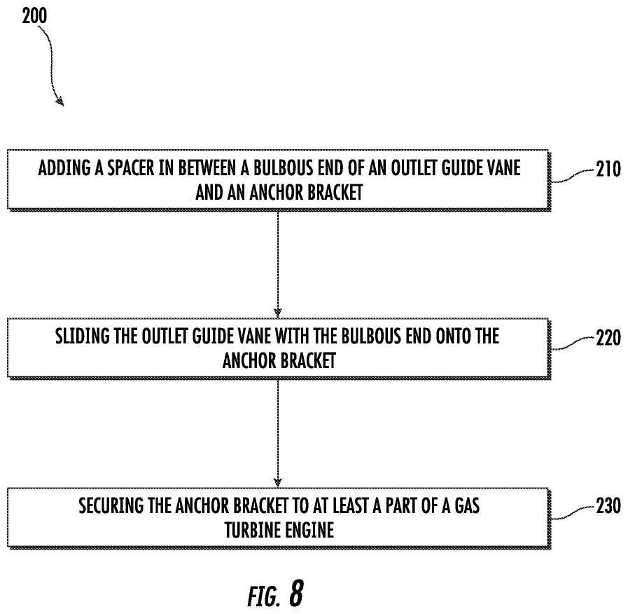

Referring now to FIG. 8, a flow diagram of a method 200 for assembling the outlet guide vane assembly 100 is described. Generally, the method 200 may include, at 210, adding the spacer 150 in between the bulbous end 120 and the anchor bracket 130; at 220, sliding the outlet guide vane 110 with the bulbous end 120 onto the anchor bracket 130 including the anchor base 132, the engagement slot 134, and at least one side structure 136; and, at 230, securing the anchor bracket 130 to at least a part of a gas turbine engine.

Specifically, at 210, the spacer 150 is added in between the bulbous end 120 and the anchor bracket 130. Generally, as mentioned previously, the spacer 150 remains in place between the outlet guide vane 110 and the anchor bracket 130 due to frictional forces and/or tension between the bulbous end 120 of the outlet guide vane 110 within the engagement slot 134 of the anchor bracket 130. However, in alternative and/or additional embodiments, the spacer 150 may be held in place with retention rings and/or bolts. Further, in some embodiments, the spacer 150 may include more than spacer 150, e.g., two spacers 150, three spacers 150, or four spacers 150 in order to hold the bulbous end 120 of the outlet guide vane 110 in place.

Further, at 220, the outlet guide vane 110 with the bulbous end 120 is slid onto the anchor bracket 130 including the anchor base 132, the engagement slot 134, and the at least one side structure 136 defining the engagement slot 134. In certain exemplary embodiments, the bulbous end 120 of the outlet guide vane 110 is slid into the engagement slot 134 after the spacer 150 is placed in the engagement slot 134 between the outlet guide vane 110 and the anchor bracket 130. However, the spacer 150 may also be placed in between the outlet guide vane 110 and the anchor bracket 130 after the bulbous end 120 is attached to the anchor bracket 130.

At 230, the anchor bracket 130 is secured to at least a part of the gas turbine engine 10. In some exemplary embodiments, the anchor bracket 130 is secured to an engine frame or casing of the gas turbine engine 10. However, it will be appreciated that the outlet guide vane assembly 100 may alternatively be attached to the turbomachine in any other suitable place. Additionally, securing the anchor bracket 130 using one or more attachment members 155 to a casing of the gas turbine engine 10 comprises securing the anchor bracket 130 using a nominal amount of attachment members 155, e.g., ten or less attachment members 155, five or less attachment members 155, four or less attachment members 155, or three or less attachment members 155. As described previously, the one or more attachment members 155 extend through the plurality of openings 156 in the anchor base 132 of the anchor bracket 130.

It will further be appreciated that the outlet guide vane assembly 100 and method 200 described herein may be modified to accommodate more than one outlet guide vane 110 on a single anchor bracket 130, as shown in FIG. 7. For example, the anchor bracket 130 may include more than one engagement slot 134, such as two or more engagement slots 134, such as three or more engagement slot 134, such as five or more engagement slots 134. Specifically, the outlet guide vane assembly 100 of FIG. 7 may include a first outlet guide vane 110A and a second outlet guide vane 110B, and the anchor bracket 130 may include a first engagement slot 134A and a second engagement slot 134B, with at least one side structure 136A, 136B defining the first engagement slot 134A and with at least one side structure 136C, 136D defining the second engagement slot 134B. In some embodiments, the outlet guide vane assembly 100 may include a first spacer 150A to hold the first outlet guide vane 110A in place and a second spacer 150B to hold the second outlet guide vane 110B in place. The second spacer 150B may be disposed between a bulbous profile of the second outlet guide vane 110B and the anchor bracket 130. Additionally, while FIG. 7 shows each engagement slot 134A, 134B having two side structures each, it will be appreciated that the two engagement slots 134A, 134B may alternatively share one side structure, e.g., 136B.

Further aspects of the disclosure are provided by the subject matter of the following clauses:

An outlet guide vane comprising: a monolithic body extending in an axial direction from a base to a top, wherein at least one of the base and the top comprise a bulbous profile having a thickness in a radial direction that is greater than a thickness of the monolithic body in the radial direction, wherein the radial direction is orthogonal to the axial direction; and wherein the outlet guide vane comprises a composite material.

The outlet guide vane of any preceding clause, wherein the outlet guide vane is a stator vane.

The outlet guide vane of any preceding clause, wherein both the base and the top comprise the bulbous profile.

The outlet guide vane of any preceding clause, wherein the thickness of the bulbous profile of the base and the thickness of the bulbous profile of the top are substantially similar.

The outlet guide vane of any preceding clause, wherein a ratio of the thickness of the bulbous profile to the thickness of the monolithic body in the radial direction is greater than about 1.2.

An outlet guide vane assembly comprising: an outlet guide vane comprising: a monolithic body extending in an axial direction from a base to a top, wherein at least one of the base and the top comprise a bulbous profile having a thickness in a radial direction that is greater than a thickness of the monolithic body in the radial direction, wherein the radial direction is orthogonal to the axial direction; and wherein the outlet guide vane comprises a composite material; and an anchor bracket, wherein the anchor bracket comprises: an anchor base; an engagement slot; and at least one side structure defining the engagement slot.

The outlet guide vane assembly of any preceding clause, the outlet guide vane assembly further comprising: a spacer.

The outlet guide vane assembly of any preceding clause, wherein the anchor base further comprises a plurality of openings, and wherein the outlet guide vane assembly attaches to a gas turbine engine defining an inner span and an outer span.

The outlet guide vane assembly of any preceding clause, wherein the anchor bracket is attached to an engine frame of the gas turbine engine at the inner span or the outer span with one or more attachment members.

The outlet guide vane assembly of any preceding clause, wherein the outlet guide vane has a first bulbous profile on the base and a second bulbous profile on the top, wherein the anchor bracket is a first anchor bracket coupled with the first bulbous profile, wherein the outlet guide vane assembly further comprises a second anchor bracket coupled with the second bulbous profile, wherein the first anchor bracket is attached to the inner span with one or more attachment members, wherein the second anchor bracket is attached to the engine frame at the outer span with one or more attachment members.

The outlet guide vane assembly of any preceding clause, wherein the thickness of the first bulbous profile and the thickness of the second bulbous profile are substantially the same.

The outlet guide vane assembly of any preceding clause, wherein the engagement slot is straight along the axial direction.

The outlet guide vane assembly of any preceding clause, wherein the engagement slot is tapered or curved along the axial direction.

The outlet guide vane assembly of any preceding clause, wherein the at least one side structure comprises at least two side structures, and wherein each of the at least two side structures define a groove.

The outlet guide vane assembly of any preceding clause, wherein the composite material is a polymetric matrix composite material.

The outlet guide vane assembly of any preceding clause, wherein a ratio of the thickness of the bulbous profile to the thickness of the monolithic body in the radial direction is greater than about 1.2.

The outlet guide vane assembly of any preceding clause, the outlet guide vane assembly further comprising: a second outlet guide vane, wherein the anchor bracket further comprises: a second engagement slot; and at least one side structure defining the second engagement slot.

The outlet guide vane assembly of any preceding clause, the outlet guide vane assembly further comprising: a second spacer disposed between a bulbous profile of the second outlet guide vane and the anchor bracket.

A method of assembling an outlet guide vane assembly, the method comprising: adding a spacer in between a bulbous end of an outlet guide vane and an anchor bracket, wherein the outlet guide vane comprises a monolithic body extending in an axial direction from a base to a top, wherein at least one of the base and the top comprise the bulbous profile having a thickness in a radial direction that is greater than a thickness of the monolithic body in the radial direction, wherein the radial direction is orthogonal to the axial direction, wherein the outlet guide vane comprises a composite material, and wherein the anchor bracket comprises an anchor base, an engagement slot, and at least one side structure defining the engagement slot; sliding the outlet guide vane with the bulbous end onto the anchor bracket; and securing the anchor bracket to at least a part of a gas turbine engine.

The method of any preceding clause, wherein securing the anchor bracket to at least the part of the gas turbine engine comprises securing the anchor bracket using one or more attachment members to an engine casing of the gas turbine engine.

This description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An outlet guide vane comprising:
a monolithic body extending in an axial direction from a base to a top,
wherein at least one of the base and the top comprise a bulbous profile comprising a dovetailed shape having a thickness in a radial direction that is greater than a thickness of the monolithic body in the radial direction, wherein the radial direction is orthogonal to the axial direction; and
wherein the outlet guide vane comprises a composite material, and wherein both the base and the top comprise the bulbous profile.

2. The outlet guide vane of claim 1, wherein the outlet guide vane is a stator vane.

3. (canceled)

4. The outlet guide vane of claim 3, wherein the thickness of the bulbous profile of the base and the thickness of the bulbous profile of the top are the same.

5. The outlet guide vane of claim 1, wherein a ratio of the thickness of the bulbous profile to the thickness of the monolithic body in the radial direction is greater than about 1.2.

6. An outlet guide vane assembly comprising:
an outlet guide vane comprising:
a monolithic body extending in an axial direction from a base to a top,
wherein at least one of the base and the top comprise a bulbous profile having a thickness in a radial direction that is greater than a thickness of the monolithic body in the radial direction, wherein the radial direction is orthogonal to the axial direction; and
wherein the outlet guide vane comprises a composite material; and
an anchor bracket, wherein the anchor bracket comprises:
an anchor base;
an engagement slot;
at least one side structure defining the engagement slot; and
a spacer disposed between the bulbous profile of the outlet guide vane and the anchor bracket, wherein the spacer interacts with the outlet guide vane and the anchor bracket through friction forces.

7. (canceled)

8. The outlet guide vane assembly of claim 6,
wherein the anchor base further comprises a plurality of openings, and
wherein the outlet guide vane assembly attaches to a gas turbine engine defining an inner span and an outer span.

9. The outlet guide vane assembly of claim 8, wherein the anchor bracket is attached to an engine frame of the gas turbine engine at the inner span or the outer span with one or more attachment members.

10. The outlet guide vane assembly of claim 8,
wherein the outlet guide vane has a first bulbous profile on the base and a second bulbous profile on the top,
wherein the anchor bracket is a first anchor bracket coupled with the first bulbous profile,
wherein the outlet guide vane assembly further comprises a second anchor bracket coupled with the second bulbous profile,
wherein the first anchor bracket is attached to the inner span with one or more attachment members,
wherein the second anchor bracket is attached to the engine frame at the outer span with one or more attachment members.

11. The outlet guide vane assembly of claim 10,
wherein the thickness of the first bulbous profile and the thickness of the second bulbous profile are the same.

12. The outlet guide vane assembly of claim 6, wherein the engagement slot is straight along the axial direction.

13. The outlet guide vane assembly of claim 6, wherein the engagement slot is tapered or curved along the axial direction.

14. The outlet guide vane assembly of claim 6, wherein the at least one side structure comprises at least two side structures, and wherein each of the at least two side structures define a groove.

15. The outlet guide vane assembly of claim 6, wherein the composite material is a polymetric matrix composite material.

16. The outlet guide vane assembly of claim 6, wherein a ratio of the thickness of the bulbous profile to the thickness of the monolithic body in the radial direction is greater than about 1.2.

17. The outlet guide vane assembly of claim 7, the outlet guide vane assembly further comprising:
a second outlet guide vane,
wherein the anchor bracket further comprises:
a second engagement slot; and
at least one side structure defining the second engagement slot.

18. The outlet guide vane assembly of claim 17, the outlet guide vane assembly further comprising:
a second spacer disposed between a bulbous profile of the second outlet guide vane and the anchor bracket.

19. A method of assembling an outlet guide vane assembly, the method comprising:
adding a spacer in between a bulbous end of an outlet guide vane and an anchor bracket wherein the spacer interacts with the outlet guide vane and the anchor bracket through friction forces,
wherein the outlet guide vane comprises a monolithic body extending in an axial direction from a base to a top,
wherein at least one of the base and the top comprise a bulbous profile having a thickness in a radial direction that is greater than a thickness of the monolithic body in the radial direction, wherein the radial direction is orthogonal to the axial direction,
wherein the outlet guide vane comprises a composite material, and
wherein the anchor bracket comprises an anchor base, an engagement slot, and at least one side structure defining the engagement slot;
sliding the outlet guide vane with the bulbous end onto the anchor bracket; and
securing the anchor bracket to at least a part of a gas turbine engine.

20. The method of claim 19, wherein securing the anchor bracket to at least the part of the gas turbine engine comprises securing the anchor bracket using one or more attachment members to an engine casing of the gas turbine engine.

21. The outlet guide vane assembly of claim 6, wherein the anchor bracket is a unitary structure.

22. The outlet guide vane assembly of claim 19, wherein the anchor bracket is a unitary structure.
